(19) United States
(12) Patent Application Publication
(10) Pub. No.: US 2004/0245087 A1
(43) Pub. Date: Dec. 9, 2004

(54) Water discharge in a dielectric barrier discharge system to generate an ozonated water

(76) Inventor: Hag-Joo Lee, Mapo-ku (KR)

Correspondence Address: Gregory P LaPointe, Bachman & LaPointe, Suite 1201, 900 Chapel Street, New Haven, CT, 06510-2802, US

(21) Appl. No.: 10/488,572

(22) PCT Filed: Sep. 10, 2002
(86) PCT No.: PCT/KR02/01702

(30) Foreign Application Priority Data
Sep. 10, 2001 (KR) 2001-55506

(51) Int. Cl. H05F 3/00; B01J 19/08; B01J 19/12

(52) U.S. Cl. 204/164; 422/186.07

(57) ABSTRACT

There are provided an apparatus and a method for producing an ozonated water by a water discharge in a dielectric barrier discharge system. The apparatus comprises high voltage alternating current power supply unit, water supply unit, oxygen supply unit, water discharge unit. The apparatus and the method do not require any dissolving module, contrary to the conventional apparatus. Further, the apparatus and the method makes it possible to produce more highly concentrated ozonated water than the conventional pulsed corona discharge system.

### TECHNICAL FIELD OF THE INVENTION

The present invention relates to an apparatus and a method for producing an ozonated water by a water discharge in a dielectric barrier discharge system. The apparatus and the method according to the present invention can be used for etching and cleaning in the manufacture of the semiconductor and TFT-LCD. They are also useful to the facilities for the purification of a drinking water, treatment of foul water, sewage and wastewater, and sterilization/disinfection thereof in the environmental field.

### BACKGROUND OF THE INVENTION

According to the conventional technique generally used for the production of an ozonated water, a gas state ozone was firstly generated from an air or an oxygen gas and the ozone thus generated was then dissolved into a water to produce the ozonated water. The conventional apparatus necessarily required ozone generator which generates ozone, and an ozone dissolving module which contacts the generated ozone with a water to produce an ozonated water. In general, the method for the generation of the ozone is classified into an electrolytic method, an ultraviolet radiation method or an electric discharge method. Among them, the electric discharge method was most popularly used one because its efficiency was far superior to other methods of the electric discharge method, a pulsed corona discharge and a dielectric barrier discharge (DBD) were widely adopted [1]. Both of the two discharges use atmospheric pressure plasma to produce ozone and exhibit almost equal efficiency. However, the pulsed corona discharge suffers from disadvantages that high power supply is required and undesirable arc discharge occasionally occurs due to short interval between the electrodes. Therefore, it may be stated that the dielectric barrier discharge is more flexible in the design of the apparatus.

The dielectric barrier discharge (DBD), called also as a silent discharge or a micro-discharge, has been widely used after Siemens first developed it for the purpose of ozone generation in 1857. The plasma generated by the dielectric barrier discharge exists in non-thermal equilibrium state, and the temperature of the neutral gas is a little higher than room temperature while a plasma electron has 10,000-100,000 K. The difference of the dielectric barrier discharge from other forms of high voltage discharge is that plasma discharge takes place between two electrodes insulated by at least one dielectric. The special feature of this discharge is that electrons are accelerated to high energy by high voltage applied to the electrodes and the accelerated electrons collide with neutral gases to produce new charged particles or radicals. The newly generated electrons result in electron avalanche. But, the electron avalanche does not progress to an arc discharge, because the accelerated electrons are deactivated by collision with a wall. The newly generated radicals produce new compounds by forming chemical bond with other neutron particles. As a result, when the dielectric barrier discharge takes places under an air, ozone gas is obtained by 3-body recombination of one oxygen molecule included in the air with one oxygen radical produced by the collision of an oxygen molecule with the accelerated electron.

In the conventional apparatus adopting the dielectric barrier discharge for the production of an ozone water, the ozone generator produces about 2-10 wt. % (50˜150 g/M³) of ozone when more than 90% of oxygen is injected under atmospheric pressure and at a temperature of 25° C., and the dissolving module dissolves the generated ozone into a water to produce the ozonated water. The concentration of the ozonated water depends upon the concentration of the ozone generated from the ozone generator and the efficiency of the ozone dissolving module. Generally, the solubility of ozone into a water is higher than that of oxygen, and it increases as the pressure of ozone gets higher and the water temperature gets lower. Therefore, installation of a compressor and a chiller can increase the efficiency. The ozone dissolving module has been structured such that the ozone generated from the ozone generator is injected with high speed into a diffuser or a ventury tube. Currently, the ventury tube is more popular used. Frequently, additive gases that serve as a scavenger for the OH radical (for example, carbon dioxide), or hydrogen peroxide (H₂O₂) is added to the ozonated water.

Since the ozonated water can be applied into various fields, many nations have actively invested for the development of new methods for producing the ozonated water. One of the new methods is a water discharge [2], wherein the electric discharge is occurred in the water. In the previous method, about 2.5 MV/cm electric field was required for initiating a sufficient discharge between water-filled two flat electrodes. But, in the water discharge, just 10 kV/cm or more electric field was revealed to be sufficient to initiate the discharge using line-to-plane electrode structure [3-5] with a thin wire and a flat electrode or point-to-point electrode structure [6] with sharpened electrode structure, each of these structure makes it possible to form high electric field on tips of electrodes. Up to now, only pulsed corona discharge has been widely used in the water discharge. Further, a water discharge system adopting the dielectric barrier discharge was not reported.

The merit of the water discharge in the production of an ozonated water is that production and dissolution of the ozone take place at the same time, which enables to leave out the dissolving module and to compact the apparatus. According to the report [6], about 2 liter of an ozonated water with 6 mg/l concentration was produced by supplying 10 LPM of oxygen bubbles, and by applying about 1 Kwh of electric power and about 10 kV/cm of electric field. Although its efficiency was lower than the conventional one, it was verified that the amount of the dissolved ozone could be linearly increased as the electric power and the discharging frequency are increased. Especially, because the dielectric barrier discharge can use higher frequency than the pulsed corona discharge, it is expected that the dielectric barrier discharge may provide much more improved effects than the pulsed corona discharge that applies at most 300 Hz of the frequency due to the special requirement of the power supply.

### SUMMARY OF INVENTION

The object of the present invention is to provide an apparatus and a method for producing an ozonated water, in which the ozonated water is produced by directly subjecting to a discharge in a water, unlike the conventional methods which produce the ozonated water in two steps of generating an ozone and then dissolving the ozone into a water. Therefore, the apparatus according to the present invention does not require any additional dissolving module.

Another object of the present invention is to provide an apparatus and a method for producing an ozonated water, in which the ozonated water is produced by the dielectric barrier discharge. The apparatus according to the present invention comprises a high voltage, alternating current power supply unit which supplies, a water supply unit, an oxygen supply unit and a water discharge unit, in which the water discharge unit comprises two dielectric-insulated electrodes and an insulator body.

### BRIEF DESCRIPTION OF THE DRAWINGS

FIG. 1 is a cross-sectional view illustrating the principle of two-phase flow.

FIG. 2 is a perspective view of a preferred embodiment of a water discharge system in accordance with the present invention.

FIG. 3 and FIG. 4 show exemplary surface structures of electrodes and dielectrics for the water discharge system in accordance with the present invention.

FIG. 5 is a block diagram of the preferred embodiment of an apparatus for producing an ozonated water in accordance with the present invention.

### DETAILED DESCRIPTION OF THE INVENTION

The apparatus for producing an ozonated water according to the present invention comprises a high voltage, alternating current power supply unit, a water supply unit, an oxygen supply unit and a water discharge unit. More specifically, the apparatus according to the present invention comprises:

a) a power supply unit supplying high voltage and alternating current into a water discharge system;

b) a water supply unit equipped with a water tank, a pump and a chiller, which supplies a water into a water discharge system to produce the ozonated water;

c) an oxygen supply unit, which supplies at least oxygen gas into a water discharge system; and

d) a water discharge system comprising two metal electrodes insulated with one or two dielectrics and an insulator body surrounding the metal electrodes, the water discharge system producing through a dielectric barrier discharge an ozone and the ozonated water from the oxygen and the water supplied from the oxygen supply unit and the water supply unit, respectively, with the high voltage and alternating current supplied from the power supplying unit.

As referred above, the water discharge for producing the ozonated water requires a power supply unit that supplies high voltage and alternating current. The power supply unit used in the apparatus is not particularly limited. Preferably, the power supply unit supplies high voltage of 1-30 kV, more preferably 10-20 kV. Such a range make it possible to use, with an inverter and a transformer, 220 V of household power source as a power source as already well known in the art. The discharge frequency is in a range of typically 60Hz-100 kHz, more preferably 0.5-5 kHz. Here, up to 3.5 kHz of the discharge frequency can be achieved by a Silicon Controlled Rectifier (SCR) type inverter, and higher frequency can be achieved by an Insulated Gate Bipolar Transistor (IGBT) type inverter. Regarding processing capacity, an electric power supplied can be suitably adjusted. The obtained high voltage is applied to one of the electrodes and the other electrode is earthed such that about 1-30 kV of voltage is applied. The electrodes into which high voltage is applied are surrounded by the insulator body to prevent undesirable discharge with metallic materials that may exist around the electrodes.

The water supply unit comprises a water tank, a pump and a chiller. Preferably, it has a circular type, in which an ozonated water produced from the water discharge system is repeatedly supplied to the water discharge system. This circulation system increases the concentration of ozone dissolved into a water, so that highly concentrated ozonated water can be obtained. The term “water” used in the specification of the present invention should be understood to include a tap water, a deionized water, etc. The chiller used in the water supply unit plays a role to increase the solubility of ozone by lowering the temperature of the circulating water. For instance, when 1000 ppm of ozone is injected into 10° C. water, the solubility is 4-5 mg/l, but it is reduced to a half, only 2-3 mg/l for 25° C. water. Therefore, the solubility of ozone can be improved by installing the chiller that lowers the temperature of the circulating water. Meanwhile, the pump that circulates the water should be made of or coated with anti-oxidant material, because the pump is subject to an oxidation by oxidative materials generated from the self-decomposition of the ozonated water.

The oxygen supply unit injects oxygen into the water discharge system to produce the ozonated water. As an oxygen source, oxygen generated from an oxygen generator or condensed oxygen can be used. When the oxygen generator is used to supply oxygen into the water discharge system, the capacity thereof can be suitably adjusted regarding the processing capacity. According to the preferred embodiment of the present invention, the oxygen generator having the capacity of 10 L/min of oxygen was proven to be suitable for producing about 2 L of 50 ml/l concentrated ozonated water in a minute.

The oxygen can be supplied in combination with one or more additive gases to the water discharge system. Examples of the additive gases are nitrogen or argon, which raises the efficiency of the dielectric barrier discharge, and carbon dioxide that increases the half-life of the dissolved ozone. It is widely known to a person of ordinary skill to which the present invention pertains that the gas like nitrogen or argon improves the efficiency of the dielectric barrier discharge. Also, the dissolved ozone has about 30 minutes of the half-life due to OH⁻ ion present in the water that decomposes the dissolved ozone. Therefore, addition of an additive gas, which serves as a scavenger for OH radical, can remarkably decrease the decomposition of the dissolved ozone. As a scavenger for OH radical, carbon dioxide can be mentioned. The carbon dioxide dissolves into water and forms a carbonate ion. The generated carbonate ion reacts with OH radical to form a carbonate ion radical such that OH radical present in the water can be decreased and ozone decomposition can be prevented [9]. Besides the carbon dioxide, hydrogen peroxide, which has been used for disinfection, sterilization and treatment of sewage, can be added. When oxygen is supplied in combination with at least one additive gas, the concentration of the oxygen gas is preferably adjusted in a range of 15˜90%, dependent upon discharge characteristics. When the oxygen gas is supplied at a concentration of 20%, an air can be used as an oxygen source. A mass flow controller can be used to control the flow of the gas.

The oxygen supply unit that supplies the oxygen gas into the water discharge system can be constituted into various forms. For instance, an oxygen supply source (for example, an oxygen generator, a condensed oxygen supplier, etc) can be positioned on a pipe that connects the water supply unit to the water discharge system such that the oxygen is supplied in a form of a mixed media (two-phase flow). Alternatively, the oxygen can be injected into the water discharge system in a form of fine bubbles. Namely, the oxygen can be supplied in a from of two-phase flow in which an oxygen layer and a water layer are separated, or in a form of fine bubbles in which oxygen bubbles are formed within the water layer.

When the oxygen gas is supplied in a form of fine bubbles, the fine bubbles can be produced in various ways. Representatively, the fine bubbles can be formed by a bubble generator installed at an end of the oxygen supply unit, or by an injector. The diameter of the oxygen bubble is desirably equal or shorter than the interval between the two electrodes. Although the various methods including the bubble generator or a ventury tube could be adopted to make fine bubbles, the bubble generator is more preferable.

When the oxygen from the oxygen supply source is supplied in a form of a mixed media through the pipe that connects the water supply unit to the water discharge system, the oxygen is typically supplied in a form of two-phase flow in which the oxygen layer and the water layer are separated. This two-phase flow, for example, can be easily achieved by blowing the oxygen gas with moderate pressure over the flowing water using the gravity. Such a two-phase flow additionally reduces the discharge voltage and increases the concentration of ozone dissolved into the water, and the thickness of the ozone layer and the water layer can be adjusted in a suitable range. In this case, the discharge takes places in the oxygen layer. The ozone thus generated contacts the surface of the water layer under very high pressure caused by a shock wave generated during the discharge, so that much more ozone can be dissolved into the water than the normal condition.

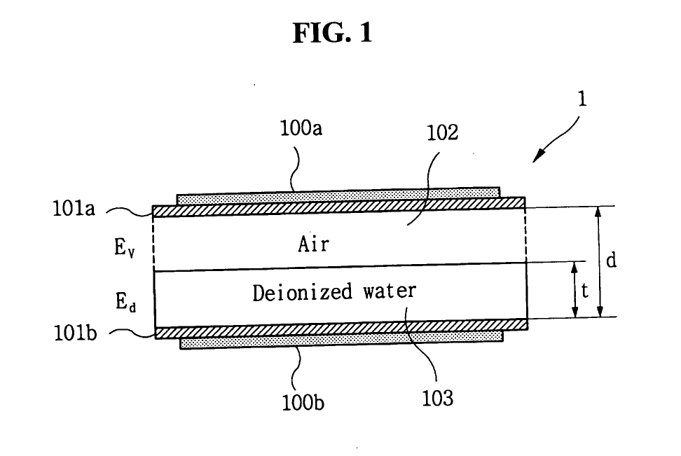

Referring to FIG. 1, the principle is more fully illustrated. When electric potential (ΔΦ) is applied between two electrodes 100a and 100b of a water discharge system 1 insulated by dielectrics 101a and 101b and filled with more than two media with different dielectric constants [for example, an air medium 102 and an deionized water medium 103], the electric field (E_{A}) formed in the air layer 102 is represented as Formula 1, and the electric field (E_{W}) formed in the deionized water layer 103 is represented as Formula 2. Further, the electric potential (ΔΦ) is represented as Formula 3, and is always conserved as shown in Formula 3.

$$\begin{matrix}{E}_{A} = \frac{K Δ Φ}{t + K ( d - t )} & Formula 1 \\ {E}_{w} = \frac{Δ Φ}{t + K ( d - t )} & Formula 2 \\ Δ Φ = {E}_{A} ( d - t ) + {E}_{w} t & Formula 3\end{matrix}$$

In Formula 1 to 3, K is a relative dielectric constant, ε_{A}, the dielectric constant for an air, is 1, and ε_{W}, the dielectric constant for the deionized water, is 90. d represents the interval between the dielectrics and t represents the height of the deionized water layer.

As shown in Formula 1 and 3 above, when predetermined electric potential is applied to the mixed media of the air layer 102 and the deionized water layer 103, the electric field (E_{A}) applied to the air layer 102 is much higher than the normal one in which only air phase is present. As a result, the discharge easily takes place even at lower electric potential. In this case, the ozone thus generated has much higher energy, that is, it shows much higher pressure. Further, the ozone gas directly contacts with water. For these reasons, tens of times higher solubility can be obtained than the conventional techniques in which generation and dissolution of ozone is performed in a stepwise. Conclusively, the apparatus of the present invention makes it possible to initiate the discharge with lower electric field and to remarkably increase the solubility of ozone. While the air 102 and the deionized water 103 were exemplarily used in the above embodiment, it would be readily understood that the same result could be obtained when oxygen, optionally in combination with other additive gas, was used instead of the air. In addition, even though the embodiment exemplifies two-phase flow with different dielectric constants, the water into which air or oxygen is present as fine bubbles would give rise similar result, even though its effect is much weakened. Meanwhile, when oxygen (or air) is supplied in a form of fine bubbles by the injector as well as two-phase flow, the discharge takes place at the oxygen layer (or air layer) of the two-phase flow, and then progresses to the oxygen present in a form of fine bubble in water.

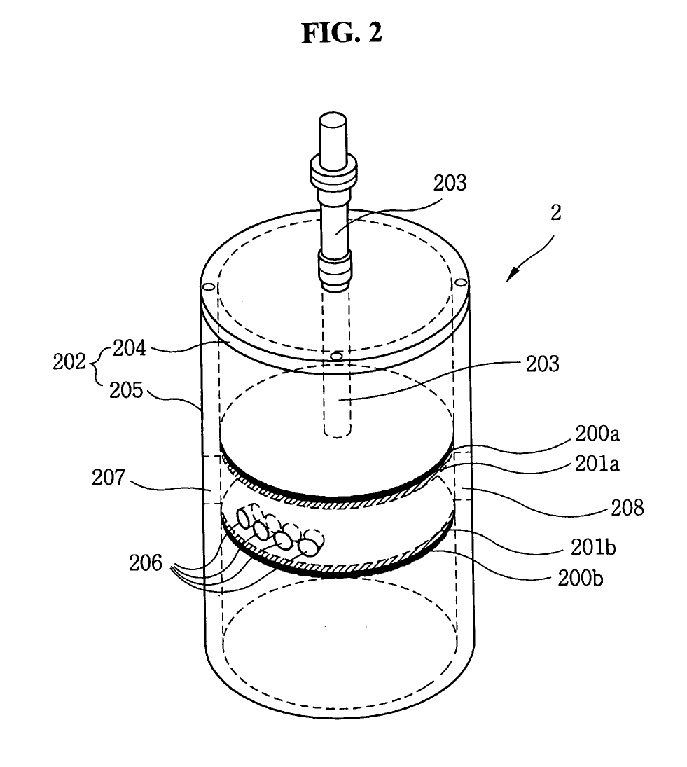

As shown in FIG. 2, the water discharge system 2 comprises two metal electrodes 200a and 200 insulated with dielectrics 201a and 201b, and an insulator body 202 surrounding the metal electrodes 200a and 200b. The electrode 200a is an earthed electrode and the electrode 200 is connected to a high voltage power source (not shown) . The metal electrodes 200a, 200 and the dielectrics 201a, 201 insulating the metal plates can be glued using an adhesive with good heat conductivity, for example ones used in a radiator. The electrodes 200a is connected to a ground rod 203 by a connection member (for example, bolt and nut). The ground rod 203 and the earthed electrode 200a are supported by an upper roof 204 of the insulator body 202 and designed to move up and down by a moving means conventionally used in the art. The side wall 205 of the insulator body 202 supports the discharge system and is equipped with an oxygen inlet 206, a water inlet 207 and an outlet 208 through which an ozonated water drains. Meanwhile, when oxygen is supplied only in a form of a mixed media, the oxygen inlet 206 and the water inlet 207 can be omitted. The oxygen and the water are respectively supplied through the oxygen inlet 206 and the water inlet 207, and then they undergo the dielectric barrier discharge by high voltage supplied from a power source to produce an ozonated water. The produced ozonated water drains through the outlet 208. The connection of the electrodes 200a and 200 to the insulator body 202 can be achieved by a connection member such as an adhesive. The thickness of the dielectrics 201a, 201 covering the metal electrodes 200a, 200b, the distance between dielectrics 201a and 201b, and the voltage applied can be suitably chosen regarding discharge efficiency. According to the preferred embodiment of the present invention, 1-5 cm, preferably about 1-3 cm, most preferably about 2 cm of discharge space formed an effective electric field when 20 kV of voltage is applied.

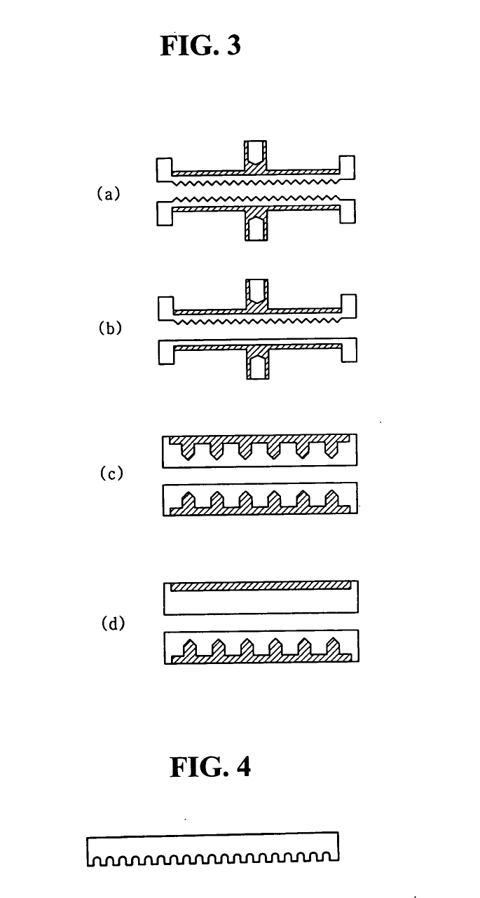

The surface structures of the dielectrics and the electrodes can be widely varied, provided that a dielectric barrier discharge is adopted. For instance, the electrode structure may be chosen from: a structure in which each of the electrodes has flat surface and each of the dielectrics has a shape of a pyramid, a triangular peak or a cone as shown in FIG. 3a; a structure in which each of the electrodes has flat surface and one of the dielectrics has a shape of pyramid, a triangular peak or a cone and the other has flat surface as shown in FIG. 3b; a structure in which each of the electrodes has a shape of a pyramid, a triangular peak or a cone and each of the dielectrics has flat surface as shown in FIG. 3c; and a structure in which one of the electrodes has a shape of a pyramid, a triangular peak or a cone and the other has flat surface and each of the dielectrics has flat surface as shown in FIG. 3d. All of these structures may be mentioned as point-to-point or line-to-point arrangement. These structures reduce the voltage required for a water discharge, because very high electric field is locally focused on a small area, for example, tip of the surface of the dielectrics [8].

Besides point-to-point or line-to-point arrangement, dented hollows can be formed on the surface of the dielectric instead of a pyramid, a triangular peak or a cone shape oxygen gases are kept in the hollows due to surface tension as shown in FIG. 4. When high voltage is applied, discharge initiates from the oxygen gas kept in the hollows, and then progresses to the main discharge. In this case, the electrode structure is not particularly limited. It can be flat or pyramid shape.

Furthermore, both the dielectrics and the electrodes may have flat surfaces. This structure has a merit to avoid molding of the dielectrics and the electrodes. In this case, the oxygen is desirably supplied into the water discharge system in a form of two-phase flow.

Preferably, the apparatus according to the present invention further comprises an ozone remover to remove excess ozone that is not dissolved. The ozone remover is connected through a pipe to the outlet for an ozonated water. It removes excess ozone that is not dissolved into the water such that environmental pollution caused by emission of the ozone gas to the surrounding is prevented. Namely, The ozone remover enables to satisfy environmental requirements. Preferably, the ozone remover is a wet scrubber, in which the reduced ozone is emitted to the environment and the water into which low concentration of ozone is dissolved is transported to a circulation unit.

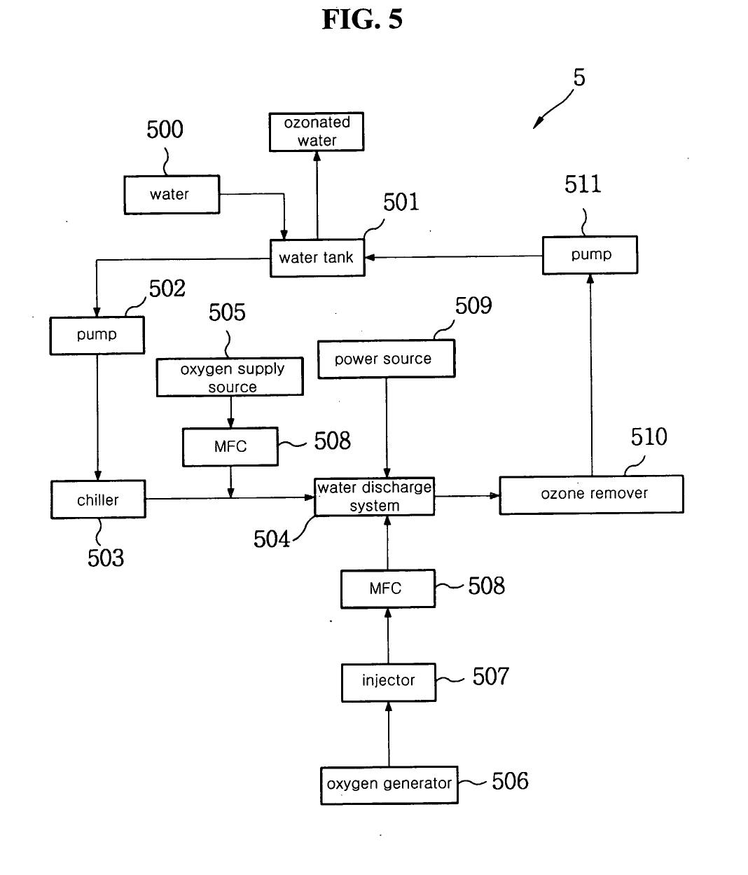

FIG. 5 shows a block diagram of the preferred embodiment of the apparatus 5 in accordance with the present invention. Water 500 (including tap water or deionized water) is stored in a water tank 501 and supplied, with highly pressurized by a pump 502, into a water discharge system 504 through a chiller 503. Meanwhile, oxygen (or a mixed gas of oxygen, such as an air) is supplied, in a form of two-phase flow or a mixed form of oxygen and water, from an oxygen supply source 505 installed between the chiller 503 and the water discharge system 504. Preferable, oxygen is supplied in a form of two-phase flow. Additionally, oxygen generated from an oxygen generator 506 is supplied through an injector 507 into the water discharge system 504 in a form of fine bubbles. The flow of oxygen is preferably controlled with a mass flow controller 508. However, as referred above, it should be understood that the oxygen could be supplied from one member selected from the group consisting of an oxygen supply source 505, the combination of the oxygen generator 506 and the injector 507, or both of them.

To the water discharge system 504 having an insulated electrode structure by dielectrics, high voltage from a high voltage power source 509 is applied, and a dielectric barrier discharge with the high voltage produces ozone gases from the oxygen in water to directly produce an ozonated water. The ozonated water produced drains to an ozone remover 510. The ozone remover 510 removes the ozone gas that is not dissolved into the water to the extent that the effluent gas satisfies environmental requirements. The ozonated water passed through the ozone remover 510 is sent to the water tank 501 by an additional pump 511 and repeats the cycle referred above to produce highly concentrated ozonated water. The high concentrated ozonated water obtained is discharged from the water tank 501 and used for various applications, for example, etching and cleaning in the manufacture of semiconductor and TFT-LCD, or purification of a drinking water, treatment of foul water, sewage and wastewater, and sterilization/disinfection in the environmental field [7]. Meanwhile, the efficiency of the ozonated water could be improved by adding an additive gas such as carbon dioxide and hydrogen peroxide, as referred above.

The present invention also relates to a method for producing an ozonated water with a dielectric barrier discharge, comprising the steps of supplying oxygen and water into a water discharge system adopting a dielectric barrier discharge, performing the dielectric barrier discharge with high voltage from a power supply unit to produce an ozonated water from the oxygen and the water, and passing the ozonated water through an ozone remover to remove an excess ozone that is not dissolved. The method may increase the concentration of ozone dissolved into the water by circulating low concentrated ozonated water. The concentration of ozone dissolve into the ozonated water can be additionally increased by lowering the temperature of the ozonated water with a chiller. Further, point-to-point arrangement can be preferably used. If need, dented hollows can be formed on the surface of the upper electrode insulated with dielectric, so that the dielectric barrier discharge initiates from the oxygen gas kept in the hollows and progresses to the main discharge. Also, oxygen gas can be supplied between the electrodes in a form of two-phase flow having an oxygen layer and a water layer, in which the discharge initiates at the oxygen layer and then progresses to the main discharge.

According to the present invention, the apparatus for producing an ozonated water dose not require any additional dissolving module to dissolve ozone into a water, unlike the conventional ones in which generation and dissolution of ozone is performed in a stepwise. Further, the apparatus can remarkably increase the concentration of the ozonated water by utilizing higher frequency than the pulsed corona discharge. Specifically, the apparatus according to the present invention produced, by supplying oxygen in two-phase state, 1300 ml of the ozonated water with 120 mg concentration in 25 minutes. Furthermore, the highly concentrated ozonated water had a reduced pH, which increase half-life of the ozonated water. For instance, the ozonated water with a concentration of 120 mg in 1300 ml ozonated water showed 10 hours of half-life, compared with the conventional ozonated water having about 25 minute of half-life. Such an increase of half-life of the ozonated water is believed to result from the decrease of OH⁻ ion, which accelerated the decomposition of the dissolved ozone. Namely, the pH for 130 ml of the ozonated water with 120 mg concentration was about 3, the reduced OH⁻ ion increases the half life of the ozonated water. The increased half-life of the ozonated water provides various merits in designing water treatment system.

### References

[1] U. Kogelschatz et.al, J. Phys. IV France, 7, C4-47 (1997)

[2] H. M. Jones and E. E. Kunhardt J. Phys. D: Appl. Phys, 28, 178 (1995)

[3]A. Abou-Ghazala, et.al to be published in Proceeding of pulsed power conference, 2001, Las vegas

[4] S. Espie et. al to be published in Proceeding of Pulsed Power Conference, 2001, Las vegas

[5] I. V. Lisitsyn et.al, Rev. Sci, Instrumn., 70, 3457 (1999)

[6] M. Mikula et.al, Plasma Sources Sci. Tech., 6 179 (1997)

[7] B. Sun et.al, Enviro. Sci, Technol. 34, 509 (2000)

[8] M. Abdel-Salam et.al, J. Phys. D:Appl. Phys., 34, 1219 (2001)

[9] M. Miyamoto et.al, Solid State Phenomena, 76-77, 219 (2000)

1. An apparatus for producing an ozonated water, comprising:
a) a power supply unit supplying high voltage and alternating current into a water discharge system;
b) a water supply unit equipped with a water tank, a pump and a chiller, which supplies a water into a water discharge system to produce the ozonated water;
c) an oxygen supply unit, which supplies a gas including oxygen into a water discharge system; and
d) a water discharge system comprising two metal electrodes insulated with at least one dielectric and an insulator body surrounding the metal electrodes, the water discharge system producing through a dielectric barrier discharge an ozone and the ozonated water from the oxygen and the water supplied from the oxygen supply unit and the water supply unit, respectively, with the high voltage and alternating current supplied from the power supplying unit.

2. The apparatus as set forth in claim 1, wherein the electric structure of the water discharge system is chosen from the structure chosen from: each of the electrode is a plane electrode having flat surface and is insulated with the dielectric having a surface of flat, a pyramid, a triangular peak or a cone shape; each of the electrodes is an electrode having a shape of a pyramid, a triangular peak or a cone and insulated with the dielectric insulator having flat surface; and one of the electrodes is an electrode having a shape of a pyramid, a triangular peak or a cone and the other is a plane electrode having flat surface and is insulated with the dielectric having flat surface.

3. The apparatus as set forth in claim 1, wherein the structure of the dielectric has dented hollows on the surface thereof inside which the oxygen is kept due to surface tension and the discharge initiates from the oxygen kept in the hollows and progresses to a main discharge.

4. The apparatus as set forth in claim 1, wherein the oxygen supply unit is selected from the group consisting of a combination of an oxygen supply source and an injector, a combination of an oxygen supply source and a bubble generator, an oxygen supply source installed on a pipe that connects the water supply unit to the water discharge system, and combinations thereof.

5. The apparatus as set forth in claim 1, wherein the oxygen supply unit includes an oxygen supply source installed on a pipe that connects the water supply unit to the water discharge system, and the oxygen is supplied in two-phase flow.

6. The apparatus as set forth in claim 1, wherein it is a circulative type.

7. The apparatus as set forth in claim 1, further comprising ozone remover which removes excess ozone that is not dissolved into the water.

8. The apparatus as set forth in claim 1, wherein oxygen is supplied in combination with nitrogen, argon, carbon dioxide or hydrogen peroxide into the water discharge system.

9. The apparatus as set forth in claim 1, wherein the oxygen is supplied in a form of an air.

10. The apparatus as set forth in claim 1, wherein it is used for etching and cleaning in the manufacture of semiconductor and TFT-LCD.

11. The apparatus as set forth in claim 1, wherein it is used for the purification of a drinking water, treatment of foul water, sewage and wastewater, sterilization/disinfection thereof, and oxidation of non-degradable materials.

12. A method for producing an ozonated water with a dielectric barrier discharge, comprising:
a) supplying oxygen and water into a water discharge system adopting a dielectric barrier discharge;
b) performing the dielectric barrier discharge with high voltage from a power supply unit to produce an ozonated water from the oxygen and the water; and
c) passing the ozonated water through an ozone remover to remove excess ozone that is not dissolved.

13. The method as set forth in claim 12, wherein the ozonated water is circulated to increase the quantity of the dissolved ozone.

14. The method as set forth in claim 12, wherein the oxygen is supplied in a form of two-phase flow by through and water supply is achieved through the two phase flow by installing an oxygen supply source on a pipe that connects a water supply unit to the water discharge system.
